(19) United States
(12) Patent Application Publication
(10) Pub. No.: US 2009/0287317 A1
(43) Pub. Date: Nov. 19, 2009

(54) Display control apparatus and method and display control program

(75) Inventors: Yoshitomo Kumagai, Kawasaki (JP); Junko Taira, Kawasaki (JP); Toshiro Okada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/320,525

(22) Filed: Jan. 28, 2009

(30) Foreign Application Priority Data
May 14, 2008 (JP) 2008-126913

(51) Int. Cl. G05B 15/00

(52) U.S. Cl. 700/1

(57) ABSTRACT

According to an aspect of the embodiment, a display control apparatus includes a storage unit storing a plurality of connection information each of which is associated at least with one property information, an extraction unit extracting connection information from the plurality of connection information, the extracted connection information including property information which partially correspond with each other, and a display unit performing display control to distinguish the extracted connection information extracted by the extraction unit from the other connection information.

### CROSS-REFERENCE TO RELATED APPLICATIONS

This application is based upon and claims the benefit of priority of the prior Japanese Patent Application No. 2008-126913, filed on May 14, 2008, the entire contents of which are incorporated herein by reference.

### FIELD

The embodiments discussed herein are related to a display control apparatus and method and a display control program.

### BACKGROUND

A design of an electronic apparatus such as a computer largely depends on CAD (Computer Aided Design). In processing of the design, inner connections of the electronic apparatus which is an object of the design is displayed on a screen. In such display, it is required to represent to easily understand connections in devices on the screen, and facilitate the editing operation of the connections.

For example, a network structure diagram displaying method is discussed in which connections between a network apparatus and a plurality of connection ports on a network relay device can be easily recognized on a screen in displaying network structure (Japanese Laid-Open Patent Publication No. 2001-308873).

Further, displaying of a logical circuit diagram having a representing structure for multiple bits is discussed in which the logical circuit diagram is represented by a symbol indicating a circuit function, a connection line called a bundle line which represents multiple bits, and a bus symbol which is drawn nearly perpendicular to the connection line and can represent bundling of lines into the bundle line and selection of a line out from the bundle line (Japanese Laid-Open Patent Publication No. 62-272367).

Further, a diagram editing apparatus is discussed that describes connection lines overlapping with each other as a connection line and, when first connection line is overlapped with an end of second connection line or a pin which is a parts of the second connection line, separates the first connection line and determines dynamically the first connection line based on a property of the first connection line and a relation of positions of the connection lines (Japanese Laid-Open Patent Publication No. 09-153070).

### SUMMARY

According to an aspect of the embodiment, a display control apparatus includes a storage unit storing a plurality of connection information each of which is associated at least with one property information, an extraction unit extracting connection information from the plurality of connection information, the extracted connection information including property information which partially correspond with each other, and a display unit performing display control to distinguish the extracted connection information extracted by the extraction unit from the other connection information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a structure of a drawing data processing apparatus having a display control apparatus.

FIG. 2 is an illustration of a data structure in the display control apparatus.

FIG. 3 is an illustration of display control processing performed by the display control apparatus.

FIG. 4 is a flowchart of display control processing performed by the display control apparatus.

FIGS. 5, 6 and 7 are illustrations of display control processing performed by the display control apparatus.

FIGS. 8, 9, 10 and 11 are diagrams illustrating examples of display screens in the display control apparatus.

FIG. 12 is a flowchart of display control processing performed by the display control apparatus.

FIGS. 13A and 13B are illustrations of examples of processing in the display control apparatus.

FIGS. 14 and 15 are illustrations of display control processing performed by the display control apparatus.

FIG. 16 is a diagram illustrating examples of display screens in the display control apparatus.

FIGS. 17 and 18 are diagrams illustrating yet other display control processing by the display control apparatus.

FIG. 19 is a diagram illustrating another display control processing by the display control apparatus.

FIGS. 20 and 21 are diagrams illustrating yet other display control processing by the display control apparatus.

FIGS. 22 and 23 are diagrams illustrating display control processing that is a background of the present invention.

### DESCRIPTION OF EMBODIMENTS

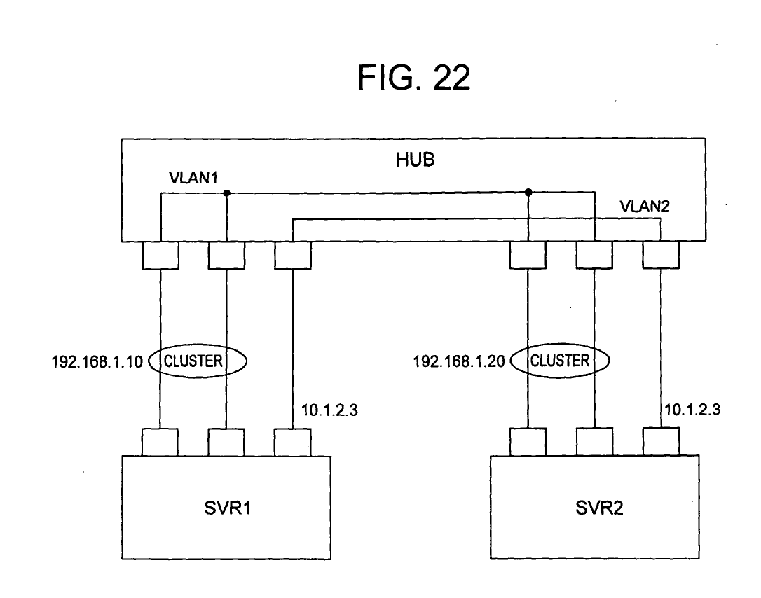

We study a display control processing for a network apparatus illustrated in FIG. 22. The network apparatus houses many CPUs (Central Processing Units) and a network switch such as a HUB in a single enclosure like a blade server. In this example, a first server SVR1 and a second server SVR2 are connected through a HUB by a first network VLAN1 for operational purposes and a second network VLAN2 for a maintenance purpose. The first network VLAN1 forms a cluster. That is, either of the two connection lines is used. The first and the second servers SVR1 and SVR2 are assigned network addresses “192.168 . . . ”

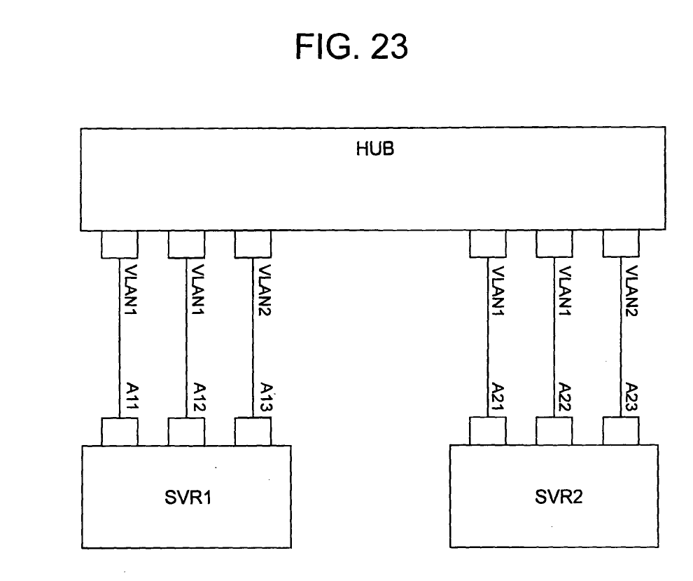

The network apparatus illustrated in FIG. 22 is displayed as a diagram illustrated in FIG. 23, for example. In the connection display illustrated in FIG. 23, many connection lines which connects the HUB and the first and the second servers SVR1 and SVR2 are displayed in a region between the HUB and the first and the second servers SVR1 and SVR2 (referred to as a “display region”). In addition to this, it is necessary to display a network name and a network address together with each of the many connection lines. The network name is displayed as “VLAN1”, for example. The network address is displayed as “A11”, for example. “A11” is an abbreviation of the network address “192.168 . . . ”, for example, to simplify the drawings.

As it is apparent from FIG. 23, grouped connections such as a cluster “VLAN1” cannot be recognized without reading the network name. In addition, the display region between the HUB and the servers SVR1 and SVR2 is limited in space. Thus, a number of characters which can be displayed in the display region is limited, or a size of the characters should be reduced. For these reasons, it is difficult for a designer to read the network name.

According to the display control apparatus and method and the display control program, the connection information which have at least a part of property information in common are extracted from a plurality of connection information and displayed as distinguished from the other connection information. Thus, a group of connection lines can be displayed as distinguished from the other connection lines. That enables a designer to recognize the group of connection lines at sight without reading the group name like a network name on the screen. That means the designer can recognize a group of connection lines regardless of any limitation on the display region between the circuit elements such as a HUB and a server on the screen. Accordingly, connections in the display object device can be represented to easily understand on the screen, and accordingly, the designer can easily edit the connection in the display object device.

Preferred embodiments of the present invention will be explained with reference to accompanying drawings.

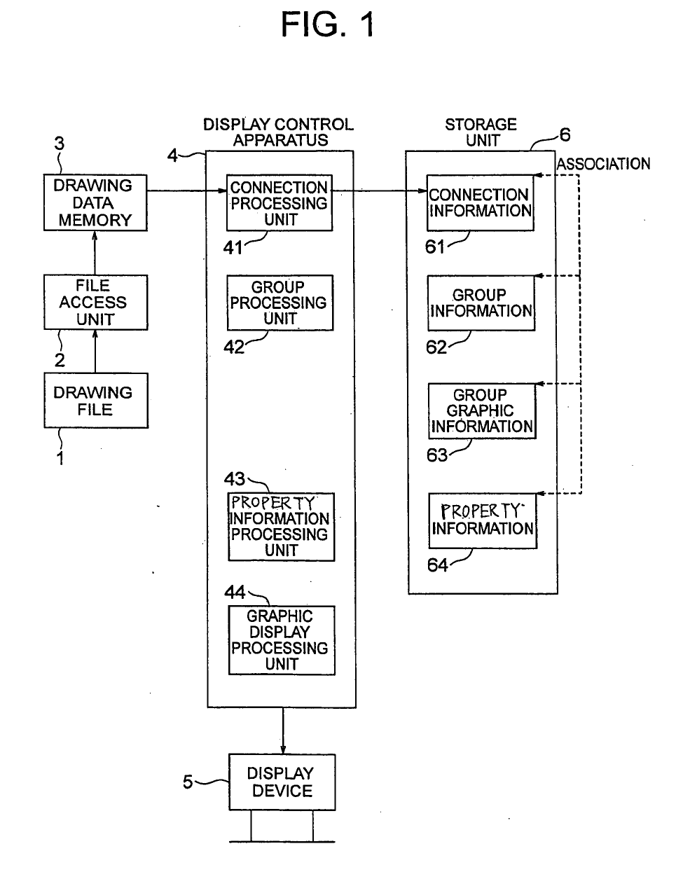

FIG. 1 is a diagram illustrating an example of a structure of a drawing data processing apparatus having a display control apparatus of an embodiment.

The drawing data processing apparatus includes a drawing file 1, a file access unit 2, a drawing data memory 3, and a display control apparatus 4. The display control apparatus 4 includes a display device 5 and a storage unit 6. The display device 5 is actually a terminal device having an input device such as a keyboard. It may also be considered that the drawing file 1, the file access unit 2, and the drawing data memory 3 form a part of the display control apparatus 4.

The drawing file 1 is a file (or a file device) which stores data of a display object drawing (drawing data). The file access unit (or a file access device) 2 reads drawing data, which is indicated or instructed in an input, from the drawing file 1 according to the input from the input device, and stores the drawing data in the drawing data memory 3. The drawing data memory 3 is a memory (storage device) used by the display control apparatus 4, and stores the drawing data which is read by the file access unit 2 and is to be an object of a display processing by the display control apparatus 4.

The display control apparatus 4 displays the drawing data stored in the drawing data memory 3 on the display device 5. In the displaying process, the display control apparatus 4 generates various information, which is necessary to a display control, according to an input from the input device, stores the generated information in the storage unit 6, and performs the display control based on the information in the storage unit 6. The storage unit 6 is a memory (storage device) which is used by the display control apparatus 4.

The display control apparatus 4 is a computer having a connection processing unit 41, a group processing unit 42, a property information processing unit 43, and a graphic display processing unit 44.

The connection processing unit 41 reads the drawing data from the drawing data memory 3, generates connection information 61 based on the drawing data, and stores the connection information 61 in the storage unit 6. The group processing unit 42 generates group information 62, and stores the group information 62 in the storage unit 6. The property information processing unit 43 generates property information 64, and stores the property information 64 in the storage unit 6. The group information 62, group graphic information 63, and property information 64 are associated with the connection information 61, respectively, as indicated by dotted lines in FIG. 1.

The graphic display processing unit 44 generates group graphic information 63 based on the drawing data in the drawing data memory 3, and the connection information 61, the group information 62, and the property information 64, which are stored in the storage unit 6. Also, the graphic display processing unit 44 performs predetermined display control of the drawing data stored in the drawing data memory 3 based on the group graphic information 63, and displays the drawing data on the display device 5.

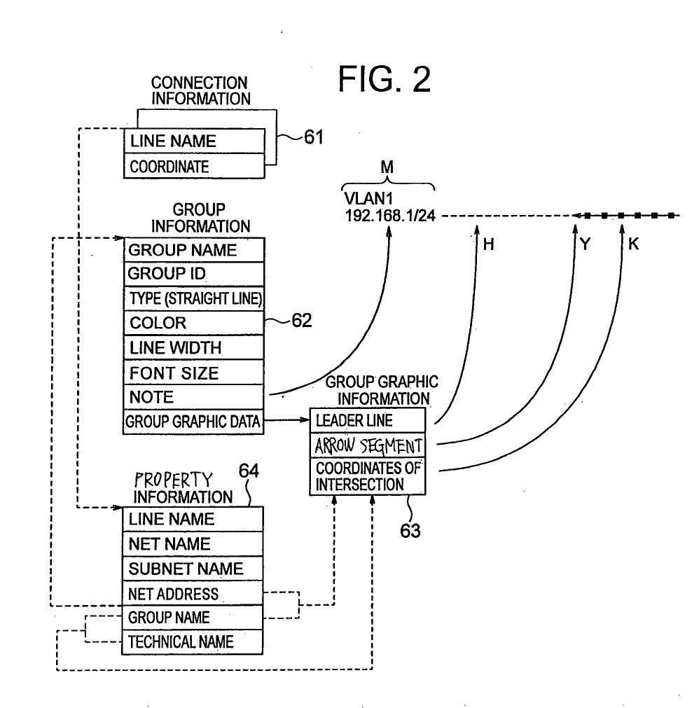

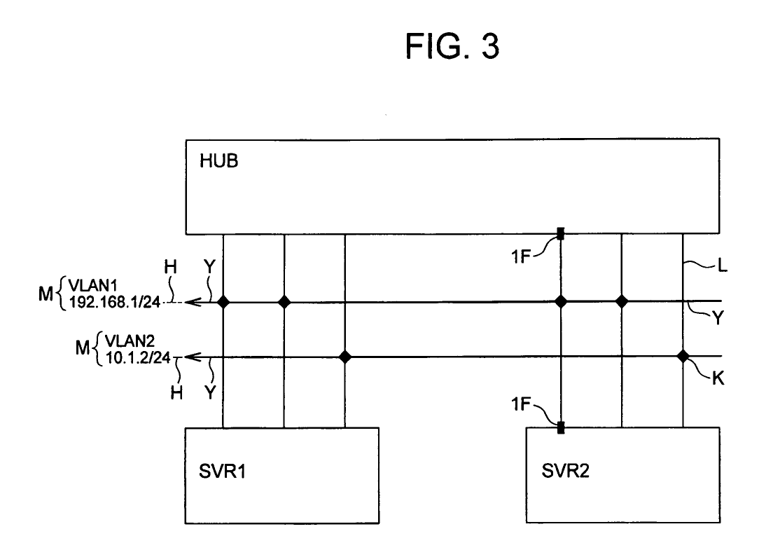

FIG. 2 is an illustration of a data structure in the display control apparatus. FIG. 3 is an illustration of display control processing performed by the display control apparatus. FIG. 3 illustrates connections of a network apparatus which is the same with the network apparatus illustrated in FIGS. 22 and 23. That is, the network apparatus of FIG. 3 is an apparatus having the HUB and the first and the second servers SVR1 and SVR2, which are connected by the clustered “VLAN1” and the other network “VLAN2”.

The connection information 61 is provided for each connection line (hereinafter, also referred to as line). The connection information 61 includes coordinates for each line name (connection line name), for example. The line name is uniquely specified or identified for each connection line L. The coordinates are those at both ends of the connection line L.

As illustrated in FIG. 3, the coordinates of both ends of the connection line L are also coordinates of interfaces (connection terminals) IF of the HUB, the SVR (server) 1 and the SVR2, which are circuit elements. The connection line L is a wiring which connects interfaces IF of two circuit elements. The both ends of the connection line L are the interfaces IF of the circuit elements. In FIG. 3, the interfaces IF are illustrated only for one connection line between the HUB and the SVR2.

As illustrated in FIG. 3, a plurality of connection lines L are drawn between the HUB, and the SVR (server) 1 and SVR2, which are the circuit elements, so as to connect the interfaces IF of them. The coordinates of the circuit elements and the both ends of the connection lines L (or interfaces IF) are predetermined by the drawing data stored in the drawing data memory 3. The connection line L is drawn so as to connect the both ends thereof. When the connection line L is a branch of a bus, coordinates of ends of the branch via the bus is used as the coordinates of the connection line L.

For example, the both ends of the connection line L (or interfaces IF) are displayed together with the circuit elements on the display device 5. When the designer specifies either (or both) of the ends, the connection line L is drawn on the display device 5, and the connection information 61 is generated. That is, the line name which is uniquely determined is given to the connection line L, and the coordinates of the interfaces IF which are connected are obtained from the drawing data.

The property information 64 is provided for each interface IF. The property information 64 includes a net name, a subnet name, a net (network) address, a group name, and a technical name for each line name. The net name is a network name, and is uniquely specified for each network. The subnet name is a name of a subordinate network which forms a part of the network, and may be decided by the designer, for example. The net address is an address of the network. The technical name is a name such as “cluster”, for example. The technical name may be a technical code.

The group name is given to a group such as a clustered network, and is uniquely specified for the group. The “group (or group name)” is distinguished from an “extracted group” which is formed by a plurality of connection lines L, that are extracted by the present embodiment. The “extracted group” indicates a plurality of connection lines L that are extracted by the present embodiment.

For example, when the connection lines L are drawn and one of the connection lines L is selected, an input screen is displayed which is for inputting the property information 64 of the selected connection line L (or the line name). The designer inputs the net name and the like from the input screen. The property information 64 is associated with the connection information 61 by the line name, and associated with the group information 62 by the group name.

The property information 64 may be inputted before the connection lines L are drawn. The connection information 61 may be a part of the property information 64. The property information 64 may be provided for each connection line L.

There is a case that the property information 64 of a plurality of connection lines L (that is, interfaces IF) partially correspond with each other, which will be described later in detail. For example, when the plurality of connection lines L are connected with the clustered network “VLAN1”, both of the group name “VLAN1” and the technical name “cluster” in the property information 64 of the plurality of connection lines L correspond with each other. Then, the plurality of connection lines L are extracted to make an extracted group.

Here, the property information 64, which is used for extracting the plurality of connection lines L or connection information 61 (used for generating the extracted group) such as the above “group name” and “technical name”, are referred to as extracting conditions.

Further, FIG. 2 illustrates an example of a display of the extracted group in which both of the group name “VLAN1” and the net address “192.168.1/24” correspond with each other in the property information 64 of the plurality of connection lines L. In this case, the extracting conditions are the “group name” and the “net address”.

The property information 64 used for extracting the extracted group, or extracting conditions, are stored in explanatory characters in the group information 62 described below.

A group information 62 is provided for each group. The group information 62 includes a group ID, a type, a color, a line width, a font size, the explanatory characters, and (a pointer to) a group graphic data for each group name. The group ID is given to each group, and uniquely specifies the group. The type defines a type of means for indicating the extracted group, or defines an extraction grouping line. The color defines a color of the extraction grouping line and a color of (a frame of) the explanatory characters M. The line width defines a line width of the extraction grouping line and a line width of (a frame of) the explanatory characters M. The font size defines a size of the explanatory characters M. The explanatory characters define a content of an explanatory notes to be displayed with the extraction grouping line (explanatory characters M). For example, the explanatory notes includes the network name and the network address. A group graphic information pointer (denoted by P) is a pointer which points the group graphic information 63 corresponding to the group information 62.

When a group (group name) is selected, an input screen is displayed which is for inputting the group information 62 of the selected group. The designer inputs the type and the like from the input screen. Then, the group information 62 of the selected group is associated with one or more connection information 61 by the group name, and associated with the group graphic information 63 by the group graphic information pointer P.

By setting the group information 62, it is possible to control whether or not to draw the extraction grouping line, to draw a leader line, and to display (the frame of) the explanatory characters. In addition, by setting the items of the group information 62, it is possible to change the color, the line type, and the line width of the extraction grouping line, the leader line, and (the frame of) the explanatory characters.

By defining the type of the extraction grouping line, it is possible to select the means for indicating the extracted group. Normally, the type of the extraction grouping line is a straight line, as illustrated in FIG. 2, for example.

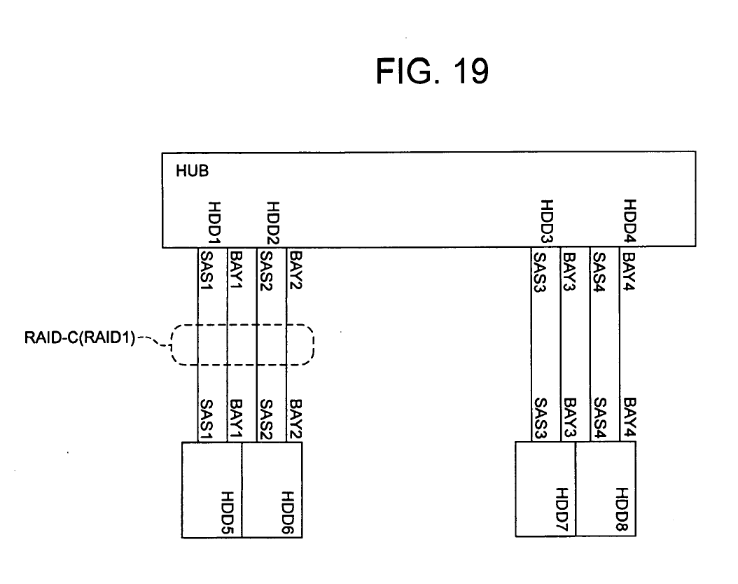

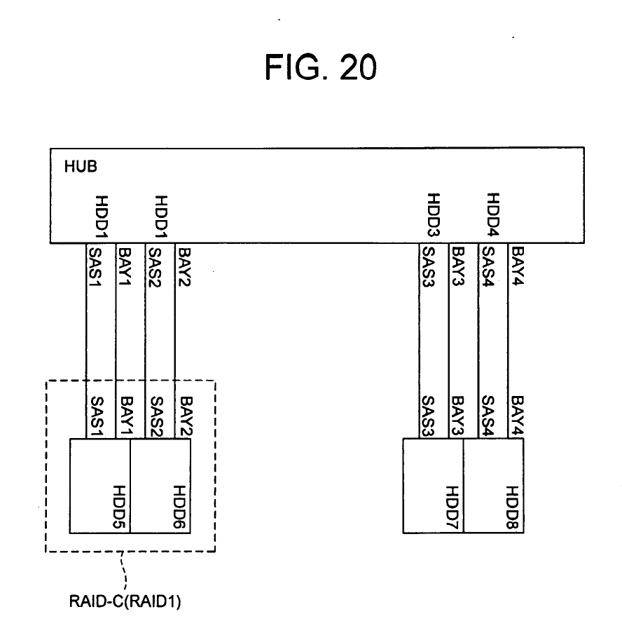

The type of the extraction grouping line is not limited to the straight line, and may be selected from various displaying way. For example, as illustrated in FIG. 19, which will be described later, a group may be indicated by a dotted line rectangle (enclosing rectangle) which encloses the connection lines L that form the group. Alternatively, as illustrated in FIG. 20, which will be described later, a group may be indicated by a dotted line rectangle (enclosing rectangle) which encloses the connection lines L that form the group.

A location and a size of the extraction grouping line may be changed. In such a case, the location and the size of the extraction grouping line may be set as the group information 62 in a same manner with the color and the line width.

The group graphic information 63 is provided so as to correspond to the group information 62, and is provided for each group. The group graphic information 63 includes leader line information (“leader line” in the figure), arrow segment information (“arrow segment” in the figure), and the connector information (“coordinates of intersection” in the figure). The leader line information is information for displaying (or drawing, which applies to the following description) a leader line H illustrated in FIGS. 2 and 3. The arrow segment information is information for displaying an arrow segment Y illustrated in FIGS. 2 and 3. The leader line H and the arrow segment Y are drawn by the number of “n”, respectively. FIG. 3 illustrates a case of n=2. The connector information is information for displaying an intersection (connector) K illustrated in FIGS. 2 and 3.

The group graphic information 63 is generated based on the group information 62 and a plurality of connection information 61, which is associated with the group information 62 via the property information 64. For example, a plurality of connection information 61 (or connection lines L) in which the group name and the net address partially correspond with each other are extracted. And, a group graphic information 63 is generated which is pointed by the group graphic information pointer P of the group information 62 having the group name partially corresponding.

In the group graphic information 63, locations of the arrow segments Y are obtained, and are used as the arrow segment information. Also, coordinates K of the intersections of the arrow segments Y and the plurality of the connection lines L are obtained, and are used as the connector information. Based on locations of tops of the arrow segments Y, locations of the leader lines H are obtained, and are used as the leader line information. Based on locations of tops of the leader lines H, the locations of the explanatory characters M are obtained.

As described above, the storage unit 6 stores the plurality of connection information 61 each of which is associated with the group information 62 and the property information 64. The connection information 61 may be associated at least with one property information 64. The graphic display processing unit 44 extracts connection information 61 in which the property information 64 at least partially correspond with each other from the plurality of connection information 61, and performs the display control so as to distinguish the extracted connection information 61 from the other connection information 61.

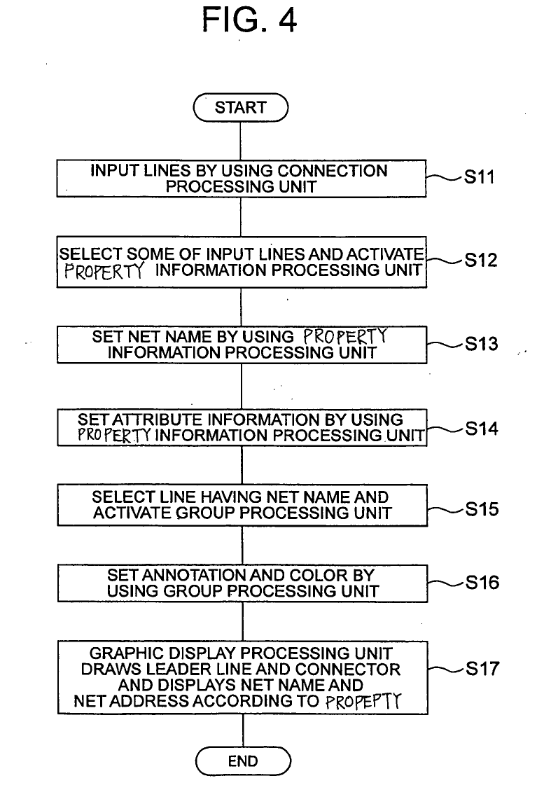

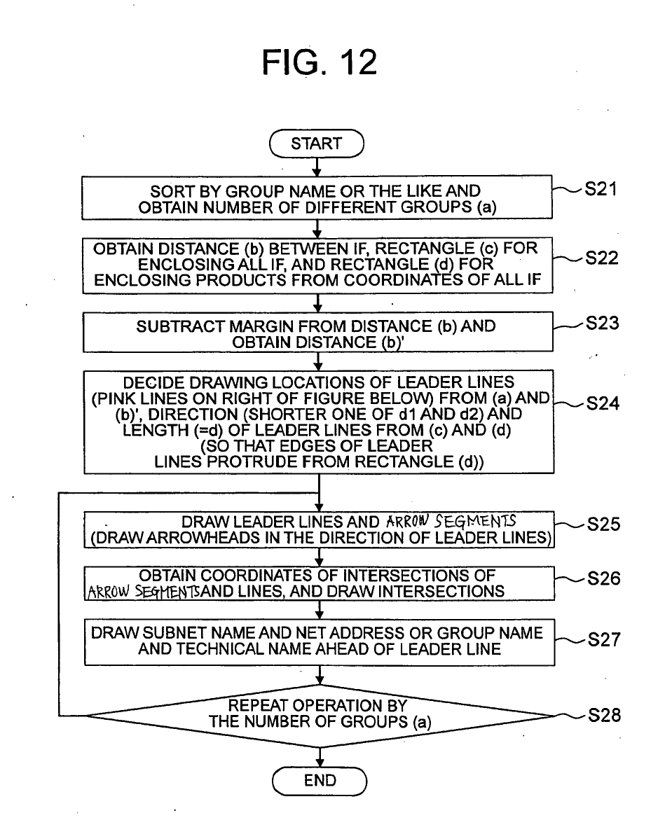

The display control performed by the display control apparatus illustrated in FIG. 1 will be detailed below mainly with reference to FIGS. 4 and 12.

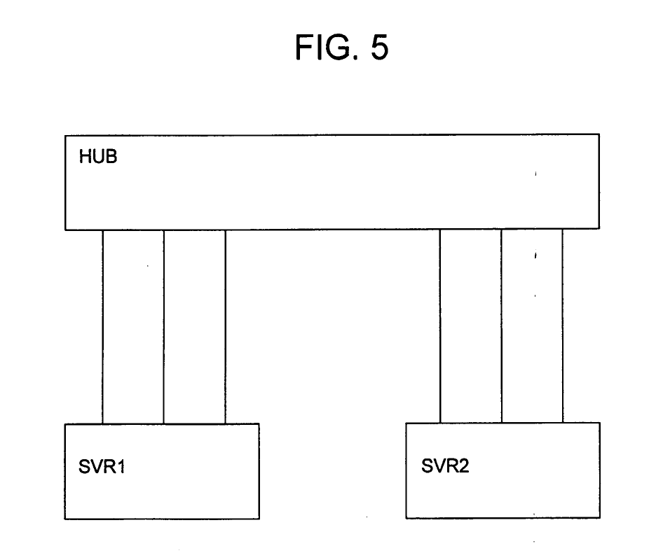

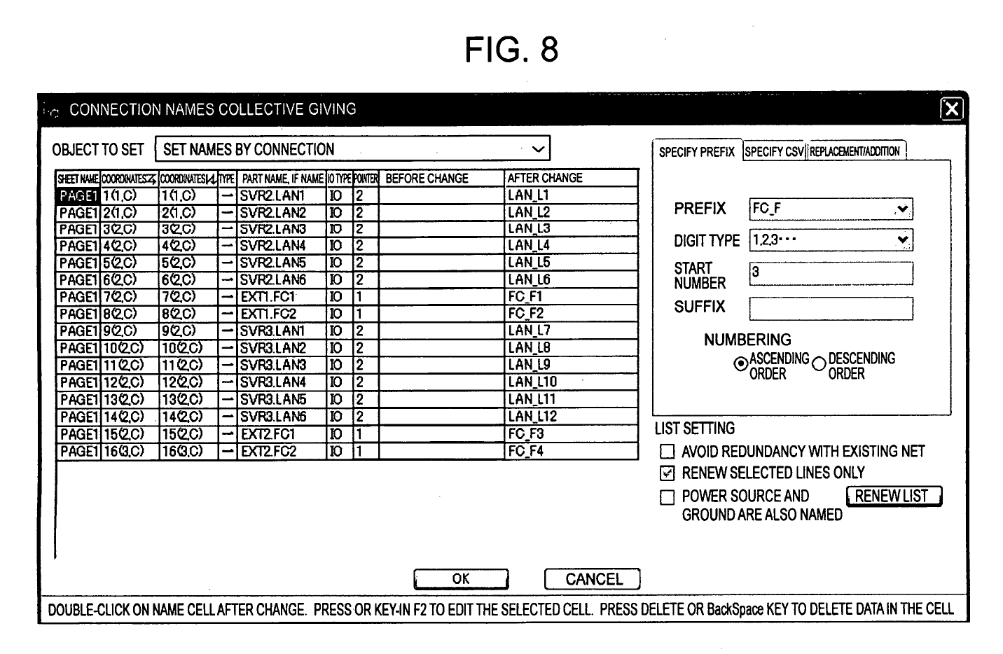

FIG. 4 illustrates a flowchart of display control processing performed by the display control apparatus illustrated in FIG. 1. FIGS. 5 to 7 are illustrations of display control processing performed by the display control apparatus. FIGS. 8 to 10 are diagrams illustrating examples of display screens displayed in the display control processing. FIGS. 5 to 7 illustrate connections of a network apparatus which is same with the network apparatus illustrated in FIGS. 22 and 23, as FIG. 3 does.

The file access unit 2 reads the drawing data indicated in an input from the drawing file 1 according to the input made by a designer via the input device, and stores the drawing data in the drawing data memory 3. In response, the graphic display processing unit 44 displays a screen in which the connection lines L are removed in FIG. 5, for example, based on the drawing data in the drawing data memory 3.

The designer looks the screen, specifies the interfaces IF, and instruct to input connection lines L (step S11). In response, the connection processing unit 41 inputs the connection lines (lines) L. Accordingly, the graphic display processing unit 44 displays the screen illustrated in FIG. 5. Also, the connection processing unit 41 generates connection information 61 for the inputted connection lines L, and stores the connection information 61 in the storage unit 6.

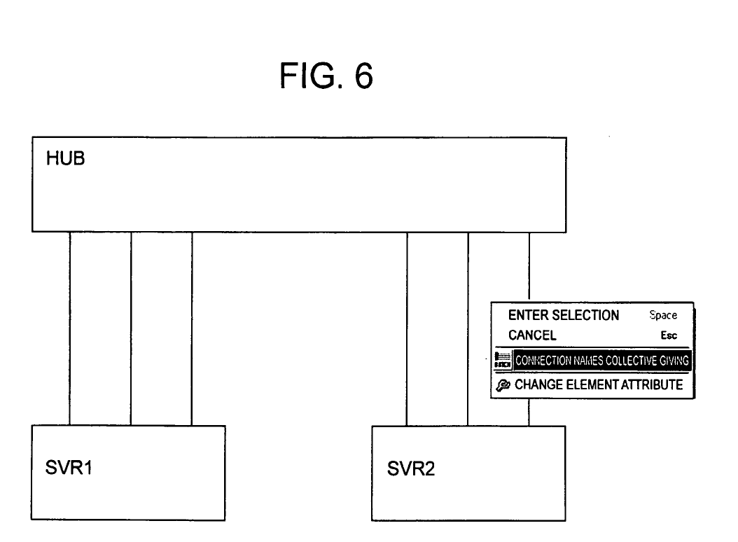

The designer looks the screen illustrated in FIG. 5, and selects some of the connection lines L inputted from the input device. In response, the graphic display processing unit 44 displays the screen illustrated in FIG. 6. The designer looks the screen, and activates the property information processing unit 43 (or an “connection names in block giving” function of the property information processing unit 43) from the screen illustrated in FIG. 6 (step S12). Accordingly, the property information processing unit 43 displays a screen in which data after changing is not inputted in FIG. 8 by the “connection names in block giving” function.

The designer looks the screen, and inputs a net name from the input device. In response, the property information processing unit 43 sets the net name in a field of the data after changing by the “connection names in block giving” function (step S13), and displays the screen illustrated in FIG. 8.

Next, the designer activates an “properties in block giving” function of the property information processing unit 43, and inputs the other items of the property information 64 (step S14).

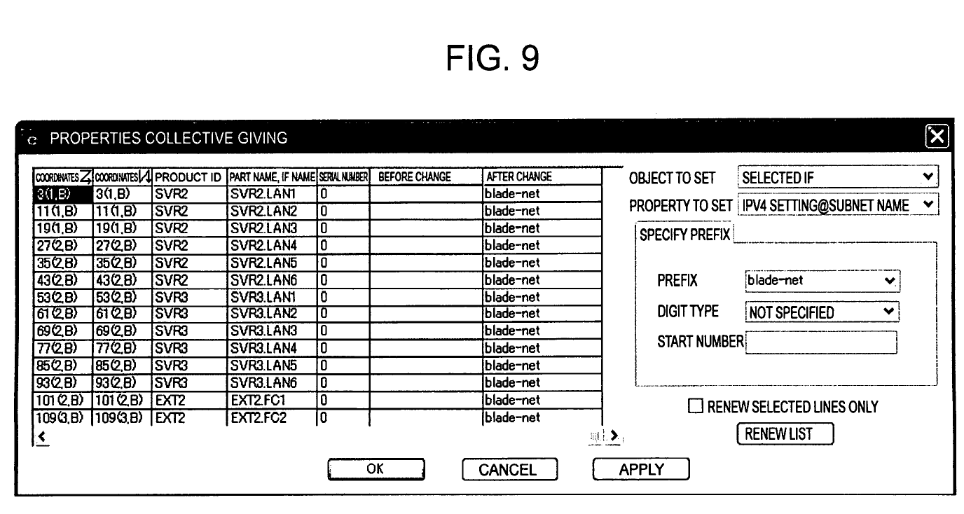

In other words, the property information processing unit 43 displays a screen in which the data after changing is not inputted in FIG. 9. Then, the designer looks the screen, and inputs a subnet name from the input device. In response, the property information processing unit 43 sets the subnet name in a field of the data after changing by the “properties in block giving” function, and displays the screen illustrated in FIG. 9.

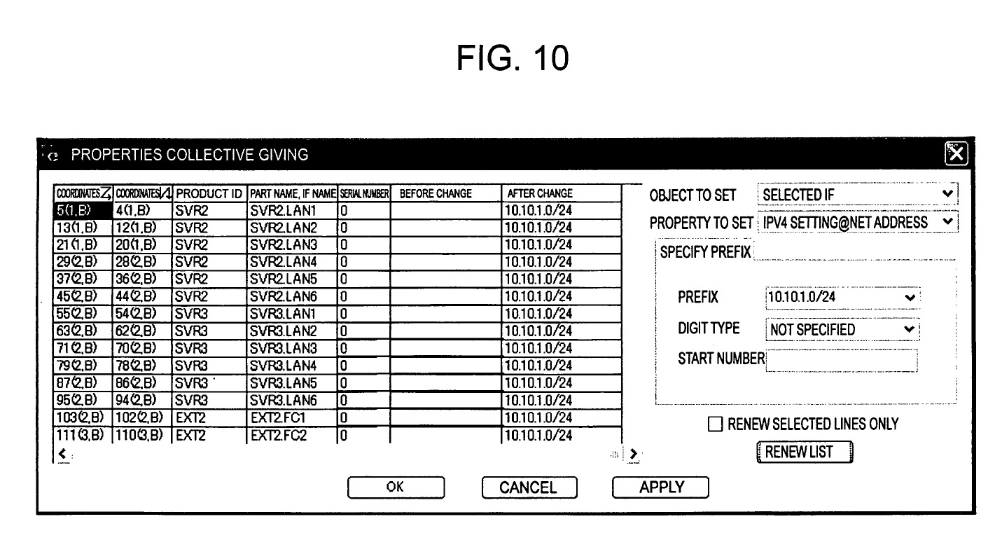

Next, the property information processing unit 43 displays a screen in which the data after changing is not inputted in FIG. 10. The designer looks the screen, and inputs a net address from the input device. In response, the property information processing unit 43 sets the net address in a field of the data after changing by the “properties in block giving” function, and displays a screen illustrated in FIG. 10.

Next, a group name and a technical name of the property information 64 are inputted in the same manner. Accordingly, completed property information 64 is generated, and stored in the storage unit 6.

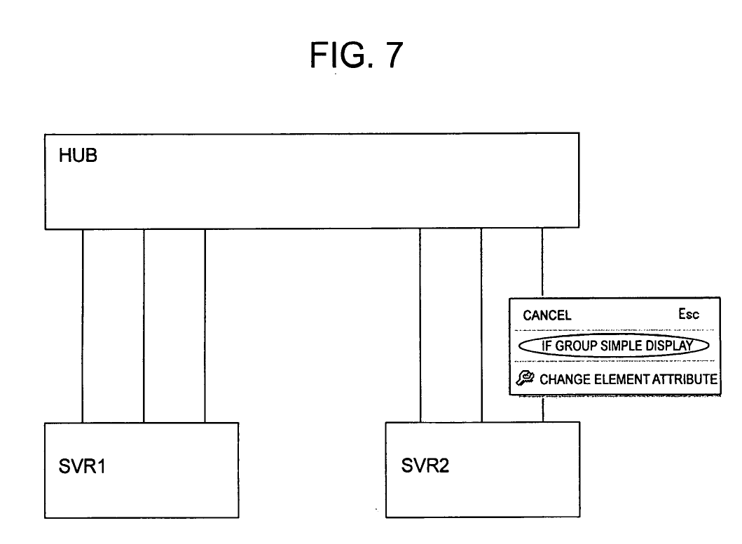

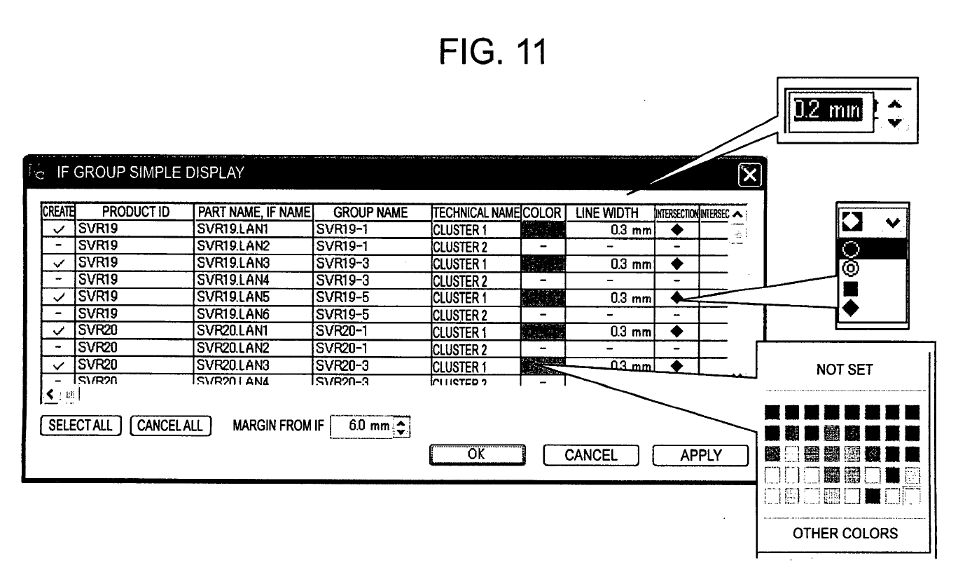

Upon completion of the input of the property information 64, the graphic display processing unit 44 displays the screen illustrated in FIG. 7. The designer looks the screen, selects the connection line L which is given the net name from the screen illustrated in FIG. 7, and activates the group processing unit 42 or the “properties in block giving” function of the group processing unit 42 (step S15). Accordingly, the group processing unit 42 displays a screen in which a color, a line width, and a type of the intersection are not inputted in FIG. 11 by the “properties in block giving” function.

The designer looks the screen, and inputs the color, the line width, and the type of the intersection. In response, the group processing unit 42 sets the color, the line width, and the type of the intersection (connector) in the screen illustrated in FIG. 11 by the “properties in block giving” function (step S16). For example, the color is set to “orange”, the line width is set to “0.3 mm”, and the type of the connector representing the intersection is set to “diamond filled with black”.

Next, the remaining items of the group information 62 are inputted in the same manner. Accordingly, completed group information 62 is generated, and stored in the storage unit 6.

Further, the group processing unit 42 generates the group graphic information 63 based on the group information 62, and stores the group graphic information 63 in the storage unit 6.

Next, according to the property information 64 and the like, the graphic display processing unit 44 draws the leader line and the connectors for the plurality of connection lines L to be grouped together, and displays the net name and the net address, both of which are attached to the leader line (step S17). In other words, in the above display control processing, the graphic display processing unit 44 graphically represents on the screen the leader line information which crosses the extracted connection information 61, and connector information at the intersections of the connection information 61 and leader line information. The processing at the step S17 is detailed in FIG. 12.

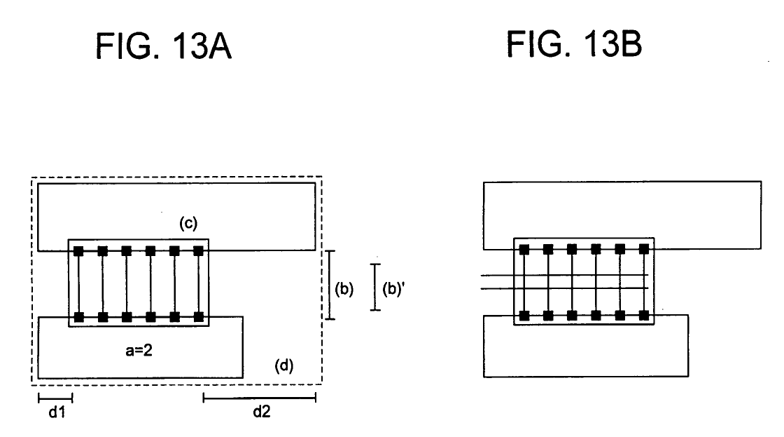

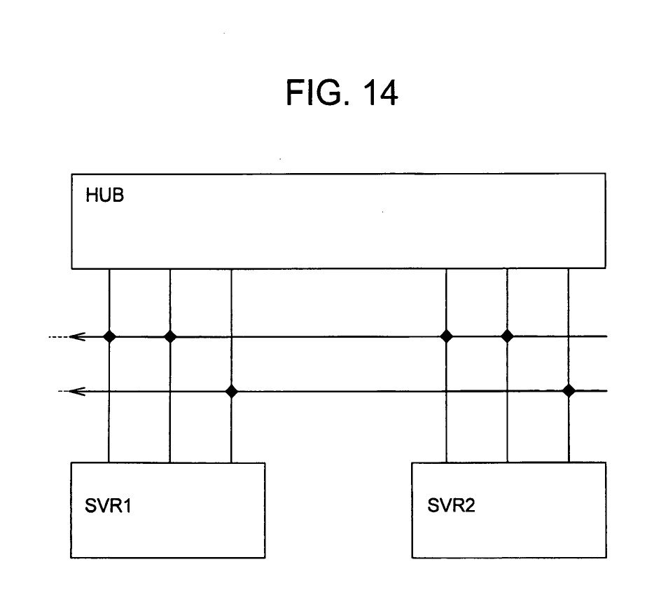

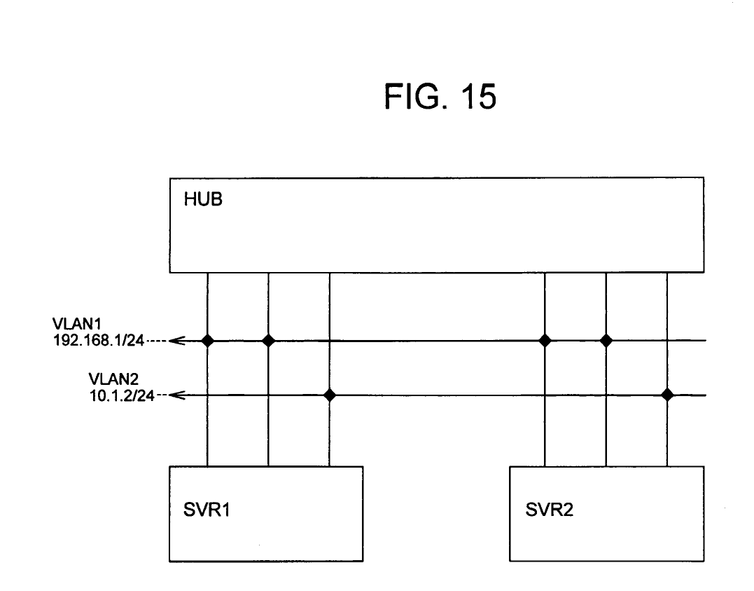

FIG. 12 is a flowchart of the display control processing performed by the display control apparatus at the step S17. FIG. 13 is an illustration of an example of processing in the display control processing. FIGS. 14 and 15 are illustrations of the display control processing performed by the display control apparatus. FIGS. 14 and 15 illustrate connection of a network apparatus which is same with the network apparatus illustrated in FIGS. 22 and 23, as FIG. 3 does.

As illustrated in FIG. 2, the graphic display processing unit 44 firstly searches the property information 64 of all of the interfaces IF, extracts a plurality of connection lines L (or a plurality of connection information 61) which have the same group name and the same technical name, for example, and make the extracted plurality of connection lines L one “extracted group”. The extracting condition in this case is the “group name” and the “technical name”. The extracted group is a group virtually set for the display control processing.

Here, the extracting condition, or the group name and the technical name, is determined that they are same with each other only when the extracting condition correspond completely, and an extracting result is grouped together into one extracted group. However, in this embodiment, other than the case that the extracting condition correspond completely, the extracting condition may be determined that they are same with each other even when the extracting condition correspond partially, and an extracting result is grouped together into one extracted group. For example, when the technical name includes a dot “.”, connection lines L, in which parts before the dots of the technical names correspond with each other, are determined that they are same with each other. More concretely, in “cluster. 1” and “cluster. 2”, parts before the dots are “cluster” and correspond with each other. Thus, the extracting condition corresponds partially, and are same.

Further, instead of the extracting condition, the property information 64 other than the group name and the technical name may be used as the extracting condition. For example, when the subnet name and the net (network) address of the property information 64 correspond partially, the connection lines L may be grouped together into one extracted group.

The property information 64 used for extracting an extracted group, or extracting condition, is used as a content of “explanatory characters” in the group information 62. For this purpose, the graphic display processing unit 44 writes the extracting condition or the property information 64 into the “explanatory characters”.

A number of the property information 64 used as the extracting condition may be one or more than three. When single property information 64 is used, the group name is used. When one or more property information 64, which is the extracting condition, correspond completely or partially, the extracting result or the connection lines L may be grouped together into one extracted group. Any part of the plurality of property information 64 may be used as the extracting condition.

After the above processing, the graphic display processing unit 44 performs display control processing of the property information 64, which at least partially corresponds with each other. In the display control, the graphic display processing unit 44 displays a plurality of property information 64 in a state that each display position of the plurality of property information 64 is shifted with each other.

First, the graphic display processing unit 44 sorts all of the connection information 61 by the group name, and obtains a number of different groups (a) having different group names (step S21). The connection information 61 may be sorted by the group ID or the like.

Next, the graphic display processing unit 44 obtains a distance (b), a rectangle (c), and a rectangle (d) based on the coordinates of the both ends of all connection lines L or interfaces IF (step S22). The distance (b), the rectangle (c), and the rectangle (d) are illustrated in FIG. 13. The distance (b) is a distance between circuit elements connected by the connection line L. In other words, the distance (b) is a distance between the interfaces IF, which is nearly equal to a length of the connection line L. The rectangle (c) is a rectangle which encloses all the interfaces IF which exist between the circuit elements connected together by the connection lines L. In other words, the rectangle (c) encloses all the connection lines L. The rectangle (d) is a rectangle which encloses all products (circuit elements) connected together by the connection lines L.

Next, the graphic display processing unit 44 subtracts a margin from the distance (b), and obtain the distance (b)′ (step S23). The margin is a difference between the distance (b) and the distance (b)′ in FIG. 13, which is equally divided and provided to both ends of the connection line L, for example. As a result, a region belonging to the distance (b)′ in the rectangle (c) is determined as a region to be performed by the display control processing, prior to an actual display control processing (steps S25 to S27). That is, the graphic display processing unit 44 performs the display control processing in the above previously determined region.

Next, the graphic display processing unit 44 decides drawing locations of the leader lines H (extraction grouping lines) based on the number of groups (a) and the distance (b)′, and decides directions and length “d” of the leader lines H based on the rectangle (c) and the rectangle (d) (step S24). The drawing locations of the leader lines H are decided based on the distance (b)′ (or the distance (b)) and the number of groups (a) so as to make intervals of each of the leader lines H equal with each other. In this embodiment, the direction of the leader lines H is decided to a shorter one of the distance (d1) and the distance (d2), both of which are illustrated in FIG. 13. The length “d” of the leader lines H is decided as nearly equal to or little bit longer than the distance (d1). Edges of the leader lines H are positioned at outside of the rectangle (d). The graphic display processing unit 44 stores the drawing locations of the leader lines H in the group graphic information 63.

Further, the graphic display processing unit 44 decides drawing locations of the arrow segments Y based on the drawing locations of the leader lines H. The drawing locations of the arrow segments Y are decided to be on extension lines from the drawing locations of the leader lines H, to be between the circuit elements, and to connect the connection lines L which form the extracted groups. The graphic display processing unit 44 stores the locations of the arrow segments Y in the group graphic information 63.

Next, the graphic display processing unit 44 draws the leader lines H and the arrow segments Y at their drawing locations based on the leader line information and the arrow segment information of the group graphic information 63 (step S25). In this drawing, arrowheads are drawn to point the direction to which the leader lines H are drawn out. Then, the graphic display processing unit 44 obtains the coordinates K of the intersections of the arrow segments Y and the connection lines L which form the extracted groups, stores the coordinates K in the group graphic information 63, and draws the intersections based on the stored coordinates K (step S26). Accordingly, the screen illustrated in FIG. 14 is displayed.

Next, the graphic display processing unit 44 draws the contents of “explanatory characters” of the group information 62 at the edges of the leader lines H (step S27). Accordingly, the screen illustrated in FIG. 15 is displayed. As described above, the contents of “explanatory characters” are the property information used for extracting the extracted groups (extracting conditions), such as the subnet name and the net address, or such as the group name and the technical name. It may be set that a part of the group information 62 and a part of the property information 64 are not displayed. For example, the net name of the bus branch may be omitted to display.

Subsequently, the graphic display processing unit 44 checks whether or not the above drawing processing of the leader lines H is repeated by the number of groups (a) (step S28). When the above drawing processing is repeated by the number of groups (a), processing of the step S25 and subsequent processings are repeated. When the above drawing processing is repeated by the number of groups (a), display processing ends.

The embodiment of the present invention is described. Various changes may be made within a scope of the invention.

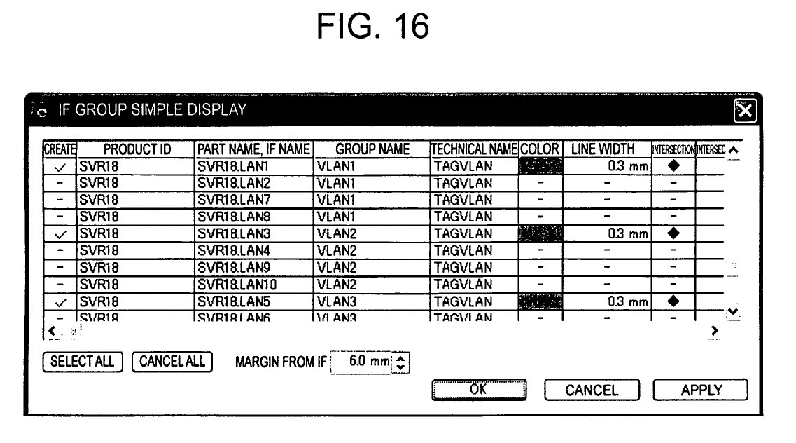

For example, the graphic display processing unit 44 may update the property information 64 which is once created as described above. In this case, the graphic display processing unit 44 displays the screen illustrated in FIG. 16. The screen is similar to the screen illustrated in FIG. 11. The graphic display processing unit 44 displays the similar screen (FIG. 16) to the screen (FIG. 11), which is for generating the property information 64, thereby the property information 64 can be inputted from the screen of FIG. 16. FIGS. 11 and 16 illustrate the property information 64 of different drawing data.

The designer looks the screen illustrated in FIG. 16, sorts the displayed table by the group name, confirms an object of the updating, and then selects the object. The object may be the extracted group of the connection lines L, the group of the circuit elements, the leader line, the net name and the like. In a state that the object is selected, a right mouse button is clicked, for example, so that the graphic display processing unit 44 displays a menu for an update processing. The designer updates the group name and the technical name from the menu, and then clicks “OK” button. In response, the graphic display processing unit 44 updates the property information 64.

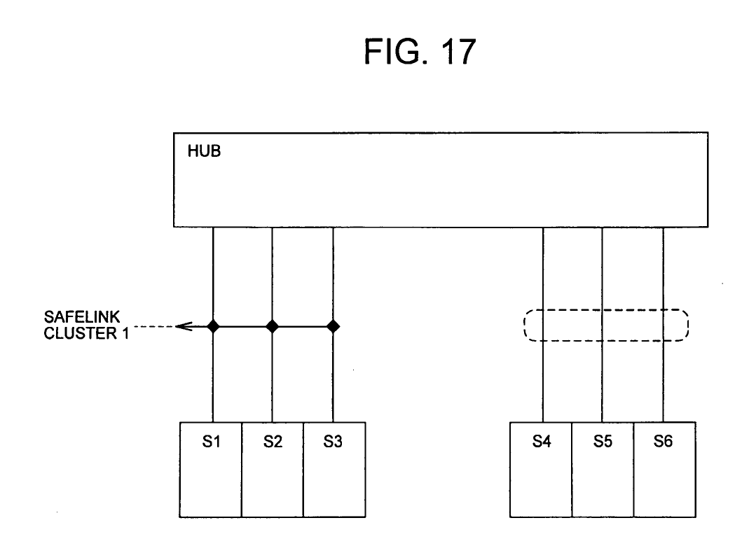

Further, the leader line and the arrow segment may also be updated. This updating may be caused by updating the group name of the property information 64 in the above-described update processing, and may invite a result that a new leader line and a new arrow segment are added. For example, as illustrated in FIG. 17, the connection lines are grouped for “SAFELINK cluster 1”, and the leader line and the arrow segment (hereinafter, referred to as an existent extraction grouping line) are drawn. In a state illustrated in FIG. 17, the property information 64 are updated. Due to this updating, it is required that a new leader line and a new arrow segment (hereinafter, referred to as a new extraction grouping line) are drawn at a location enclosed by a dotted line in FIG. 17. However, the new extraction grouping line will overlap the existent extraction grouping line.

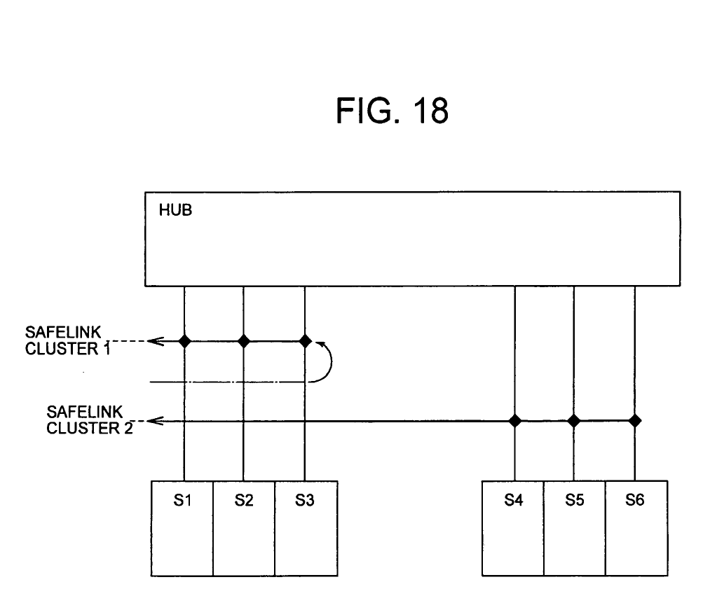

In this case, the graphic display processing unit 44 also draws the existent extraction grouping line, which overlaps the new extraction grouping line, in a drawing processing of the new extraction grouping line. Accordingly, the graphic display processing unit 44 draws two extraction grouping lines in the display region between the HUB and the servers S1 to S6, which are the circuit elements. Thus, as illustrated in FIG. 18, the existent extraction grouping line is moved upward from an original location, which is indicated by a dotted and chain line, and the new extraction grouping line is drawn below the existent extraction grouping line with equal intervals. Further, in this case, the explanatory characters such as the group names and the technical names are displayed in a state that the explanatory characters are shifted with each other.

Furthermore, the connection line L, the leader line H, the arrow segments Y, the intersection K, the explanatory characters M and the like may be drawn even when requests to do so is not inputted by the designer. In this case, the above described screen illustrated in FIG. 15 is displayed in response to activation of the graphic display processing unit 44. For this purpose, prior to the activation of the graphic display processing unit 44, the connection information 61, the group information 62, and the property information 64 are input in advance. When activated, the graphic display processing unit 44 generates the group graphic information 63 based on the connection information 61, the group information 62, and the property information 64, and displays the screen illustrated in FIG. 15 based on the group graphic information 63.

Further, for example, the type of the extraction grouping line may be set other than the “straight line”, and the means for indicating the extracted group may be set other than the “straight line”, as illustrated in FIGS. 19 and 20.

The screen illustrated in FIG. 19 illustrates an embodiment in which a group is indicated by enclosing the connection lines L which form the extracted group with a dotted line rectangle (enclosing rectangle). In this case, as illustrated in FIG. 19, the graphic display processing unit 44 draws an enclosing line which encloses a part of the connection lines L, which are extracted as one extracted group (or connection information 61), in the display control.

This embodiment is applied to a case in which circuit elements having a same group name for RAID apparatuses, link aggregations, partitioning and the like are grouped together, and display with the group name and a technical name, thereby the display is easily understood. According to this embodiment, even when the enclosing rectangle is divided into some parts, the enclosing rectangle can be displayed as separate ones. Sizes, locations, and the leader lines may be corrected for each enclosing rectangles.

The screen illustrated in FIG. 20 illustrates an embodiment in which an extracted group is indicated by enclosing the connection lines L which form a group with a dotted line rectangle (enclosing rectangle). In this case, as illustrated in FIG. 20, the graphic display processing unit 44 draws an enclosing line which encloses circuit elements connected to the connection lines L, which are extracted as one extracted group (or connection information 61), in the display control.

This embodiment is applied to a case in which clusters and the like having a same group name are grouped together, and display with the group name and a technical name, thereby the display is easily understood. According to the embodiment, same products (circuit elements) can be displayed as one group with the group name and the technical name.

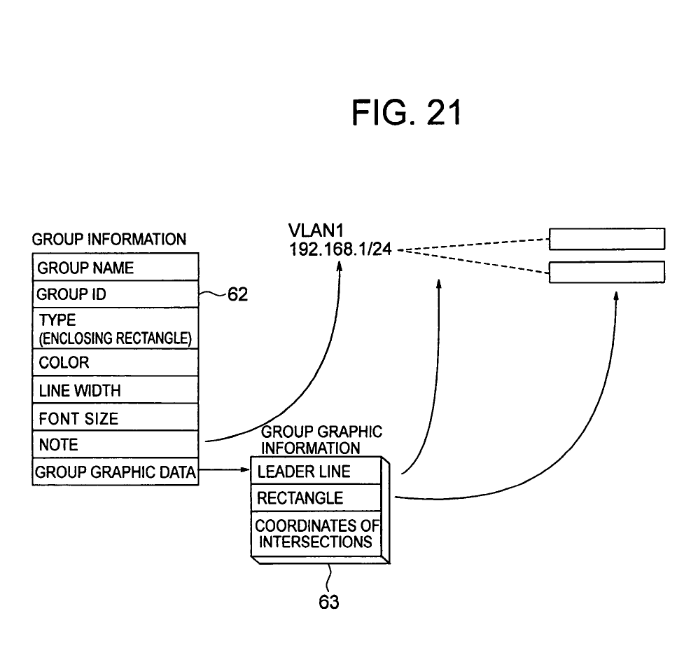

In order to display the screen illustrated in FIG. 19 or 20, the group graphic information 63 has a structure illustrated in FIG. 21. Specifically, a type is set as “enclosing rectangle” in the group graphic information 63. The graphic display processing unit 44 displays the screen illustrated in FIG. 19 or FIG. 20 based on the group graphic information 63. More concretely, the type is set as “enclosing rectangle for connection lines” in order to display the screen illustrated in FIG. 19, and the type is set as “enclosing rectangle for circuit elements (or products)” in order to display the screen illustrated in FIG. 20. Here, FIG. 21 omits the connection information 61 and the property information 64.

Further, in a case of displaying the screen illustrated in FIG. 19 or FIG. 20, the property information 64 which is once created may be updated in the above mentioned manner. Also, in this case, the graphic display processing unit 44 displays the similar screen (FIG. 16) to the screen (FIG. 11), which is for generating the property information 64, thereby the property information 64 can be inputted from the screen of FIG. 16.

All examples and conditional language recited herein are intended for pedagogical purpose to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A display control apparatus comprising:
a storage unit storing a plurality of connection information each of which is associated at least with one property information;
an extraction unit extracting connection information from the plurality of connection information, the extracted connection information including property information which partially correspond with each other; and
a display unit performing display control to distinguish the extracted connection information extracted by the extraction unit from the other connection information.

2. The display control apparatus according to claim 1, wherein the display unit performs the display control to draw arrow segment information which crosses the extracted connection information extracted by the extraction unit, and to draw connector information at each intersection of the extracted connection information and the arrow segment information.

3. The display control apparatus according to claim 1, wherein the display unit performs the display control to draw an enclosure line which encloses a part of the extracted connection information extracted by the extraction unit.

4. The display control apparatus according to claim 1, wherein the display unit displays at least on the property information which partially correspond with each other.

5. The display control apparatus according to claim 4, wherein the display unit displays a plurality of the property information which partially correspond with each other in a state that each display position of the plurality of property information is shifted with each other.

6. The display control apparatus according to claim 1, wherein the display unit performs the display control in a region which is determined prior to the display control.

7. A display control method comprising:
extracting connection information from the plurality of connection information, each of the plurality of connection information being associated at least with one property information, the extracted connection information including property information which partially correspond with each other;
display controlling to distinguish the extracted connection information extracted by the extracting step from the other connection information.

8. The display control method according to claim 7, wherein the display controlling step includes drawing arrow segment information which crosses the extracted connection information extracted by the extracting step, and drawing connector information each intersection of the extracted connection information and the arrow segment information.

9. A computer readable storage medium storing a program to cause a computer to execute display operations, the operations comprising:
extracting connection information from the plurality of connection information, each of the plurality of connection information being associated at least with one property information, the extracted connection information including property information which partially correspond with each other; and
display controlling to distinguish the extracted connection information extracted by the extracting step from the other connection information.

10. The computer readable storage medium according to claim 9, wherein the display controlling step includes drawing arrow segment information which crosses the extracted connection information extracted by the extracting step, and drawing connector information each intersection of the extracted connection information and the arrow segment information.
